(19) United States
(12) Patent Application Publication
(10) Pub. No.: US 2007/0127325 A1
(43) Pub. Date: Jun. 7, 2007

(54) Lens driving unit

(75) Inventor: Hiroshi Yamashita, Ichinomiya-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: SANYO ELECTRIC CO., LTD., Moriguchi-shi (JP)

(21) Appl. No.: 11/606,272

(22) Filed: Nov. 30, 2006

(30) Foreign Application Priority Data
Dec. 1, 2005 (JP) 2005-347805

(51) Int. Cl. G11B 7/00

(52) U.S. Cl. 369/44.14

(57) ABSTRACT

A lens driving unit includes a lens holder accommodating a lens or a group of lenses. A coil is disposed on a surface of the lens holder. The lens driving unit is provided with a magnet disposed at a position spaced from the coil by a predetermined distance to move the lens holder along an optical axis according to current flowing in the coil. The lens driving unit is further provided with a guide member guiding movement of the lens holder along the optical axis. Further, a magnetic member is disposed at the lens holder to fix a position of the lens holder by magnetic attraction force exerted by the magnet when no current flows in the coil. The lens driving unit can achieve downsizing, improved resistance to impact, stabilized lens attitude, and reduced power consumption when an auto-focus function is performed.

### BACKGROUND OF THE INVENTION

1. Field of the Invention

The present invention relates to a lens driving unit used in an imaging apparatus such as a digital camera, a mobile phone with an integrated camera, or a video camera.

2. Description of the Background Art

Conventionally, an imaging apparatus having an optical system including a plurality of lenses and having an auto-focus function and a zoom function has been used. To perform the auto-focus function and the zoom function, the imaging apparatus is provided with a lens driving unit moving the entire optical system, a single lens (or a group of lenses) for focusing, or a single lens (or a group of lenses) for zooming along an optical axis.

Examples of the lens driving unit include an actuator employing a stepping motor, a piezoelectric-type actuator utilizing distortion displacement of a crystal to which an electric field is applied, and an electromagnetic actuator utilizing a voice coil.

For example, Japanese Utility Model Publication No. 06-037228 discloses a lens driving unit moving a lens by rotating a lead screw shaft by means of a stepping motor. Further, Japanese National Patent Publication No. 2004-530172 (International Publication No. WO02/103451) discloses an actuator for auto-focusing a camera in which displacement is increased by means of a piezoelectric element having a spiral structure. Furthermore, Japanese Utility Model Publication No. 63-002997 discloses a lens driving unit using a voice coil for auto-focusing an objective lens employed in an optical pick up apparatus.

When the stepping motor described above is employed in the lens driving unit, there is caused a problem that the lens driving unit cannot be downsized because the stepping motor has a large size. Further, when the piezoelectric element is employed in the lens driving unit, although the lens driving unit can be downsized, it may easily be damaged by an impact or the like. Furthermore, when the lens driving unit employing a voice coil is used, there are caused problems that a central axis of a lens is inclined relative to an optical axis when the lens is moved along the optical axis because a lens barrel is supported by means of a spring member, and that larger power consumption is required when the auto-focus function is performed.

### SUMMARY OF THE INVENTION

One object of the present invention is to provide a lens driving unit capable of achieving downsizing, improved resistance to impact, stabilized lens attitude, and reduced power consumption when an auto-focus function is performed.

A lens driving unit of the present invention includes a lens holder accommodating one lens or not less than two lenses. A coil is disposed on a surface of the lens holder. A magnet is disposed at a position spaced from the coil by a predetermined distance to move the lens holder along an optical axis according to current flowing in the coil. A guide member guiding movement of the lens holder along the optical axis is provided. A magnetic member is disposed at the lens holder to fix a position of the lens holder by magnetic attraction force exerted by the magnet when no current flows in the coil.

According to the present invention, since a coil is used to move a lens, a downsized lens driving unit can be achieved. Further, since a guide member for guiding movement of a lens holder is provided, an improved resistance to impact is obtained, and inclination of a central axis of the lens relative to an optical axis is prevented. Furthermore, since a magnetic member is disposed at the lens holder, magnetic attraction force is generated between the lens holder and a magnet outside the lens holder. Thereby, the position of the lens holder is fixed even when no current flows in the coil after an object is focused by an auto-focus function. Consequently, power consumption in the lens driving unit is reduced.

The magnetic member described above may have a shape of a column.

The lens holder may include a through-hole formed to allow insertion of a shaft-like guide member. In this case, it is necessary that the guide member includes the shaft-like guide member inserted into the through-hole.

Further, the lens holder may include a cutout portion formed to allow insertion of a shaft-like guide member. In this case, it is necessary that the guide member includes the shaft-like guide member inserted into the cutout portion.

The lens holder may include a convex guide portion formed on a side surface thereof In this case, it is necessary that the guide member includes a concave guide portion engaging the convex guide portion.

Further, the lens holder may include a concave guide portion formed on a side surface thereof In this case, it is necessary that the guide member includes a convex guide portion engaging the concave guide portion.

Preferably, the coil is a pattern coil.

Preferably, a yoke is attached to the magnet.

Preferably, in addition to the coil, the lens driving unit further includes an additional coil disposed on a surface of the lens holder, and an additional magnet disposed at a position spaced from the additional coil by a predetermined distance to move the lens holder along the optical axis according to current flowing in the additional coil.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a perspective view of a lens driving unit in a first embodiment.

FIG. 2 is a front view of a magnet in embodiments.

FIG. 3 is a front view of an FP (Flat Pattern) coil in the embodiments.

FIG. 4 is a perspective view of a lens driving unit in a second embodiment.

FIG. 5 is a perspective view of a lens driving unit in a third embodiment.

FIG. 6 is a top view of the lens driving unit in the third embodiment.

FIG. 7 is a top view of another lens driving unit in the third embodiment.

FIG. 8 is a top view of a lens driving unit in a fourth embodiment.

FIG. 9 is a schematic cross sectional view of a camera module having the lens driving unit in the embodiments.

### DESCRIPTION OF THE PREFERRED EMBODIMENTS

Hereinafter, a lens driving unit in embodiments of the present invention will be described concretely with reference to the drawings.

### First Embodiment

Referring to FIG. 1, a lens driving unit in a first embodiment will now be described. A lens driving unit 1 in the present embodiment shown in FIG. 1 is used for a camera apparatus. Lens driving unit 1 has a lens holder 2. A group of lenses (not shown) is disposed inside lens holder 2. An FP (Flat Pattern) coil 3 is attached on one side surface of lens holder 2. FP coil 3 has a coil pattern 32. Coil pattern 32 is exposed.

A magnet 4 is disposed at a position facing FP coil 3 with a gap G therebetween. A front surface of magnet 4 faces FP coil 3. A yoke 5, which is a magnetic body, is attached on a back surface of magnet 4 by magnetic attraction. Yoke 5 is fixed on a casing of the camera apparatus not shown.

Two shaft-like guide members 71 and 72 extend from the casing (not shown). Further, lens holder 2 is provided with a circular column-shaped through-hole 21, a cutout portion 22, and a circular column-shaped through-hole 23. Through-hole 21 has a diameter substantially identical to or slightly greater than a diameter of the first shaft-like guide member 71. The first shaft-like guide member 71 is slidably inserted into through-hole 21. Cutout portion 22 has an inner wall having two flat surface portions and one curved surface portion, and the curved surface portion has a curvature radius substantially identical to or slightly greater than a radius of the second shaft-like guide member 72. The second shaft-like guide member 72 is slidable along the curved surface portion of cutout portion 22. Accordingly, lens holder 2 can be moved along shaft-like guide members 71 and 72. Further, a circular column-shaped magnetic member 6 is inserted into through-hole 23, and magnetic member 6 is fixed to an inner wall of through-hole 23 with an adhesive (not shown) or the like.

Next, operation of lens holder 2 will be described concretely.

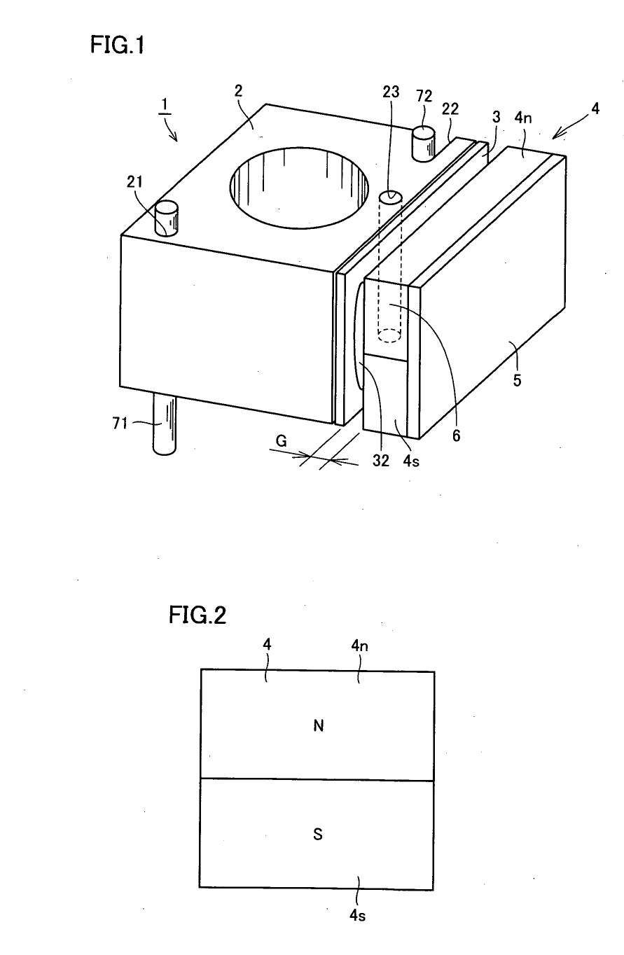

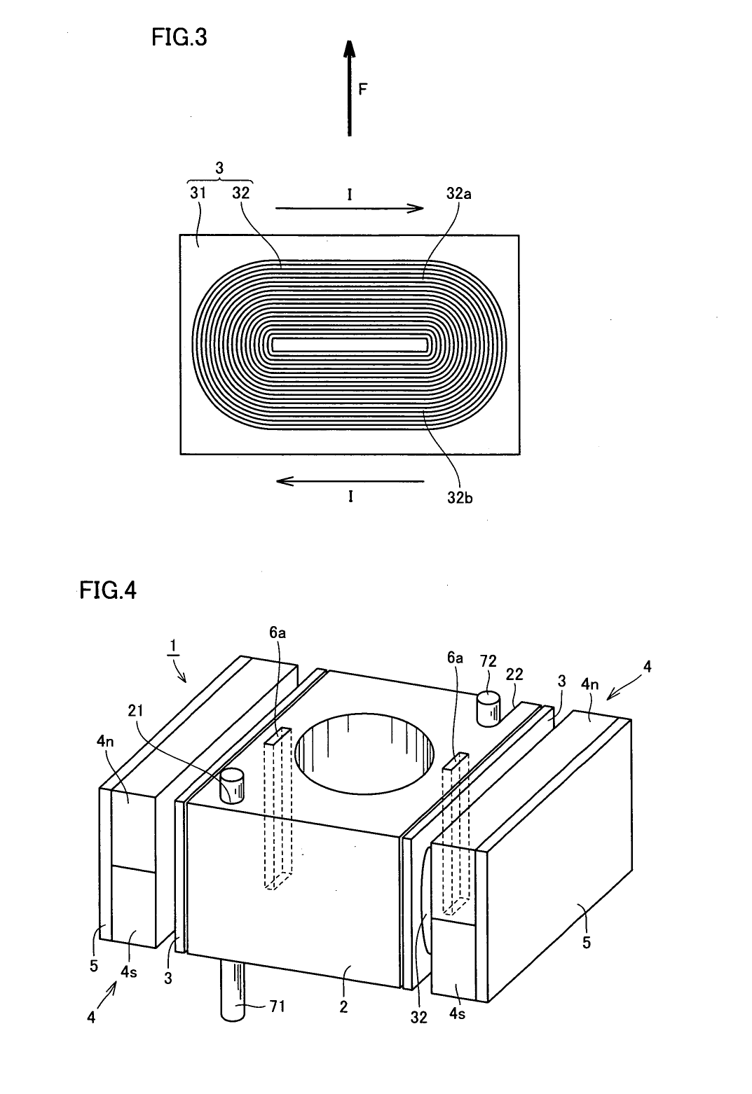

As shown in FIG. 2, magnet 4 has an N-pole magnetized region 4n and an S-pole magnetized region 4s. N-pole magnetized region 4n and S-pole magnetized region 4s are aligned in a direction in which lens holder 2 is moved.

As shown in FIG. 3, in FP coil 3, coil pattern 32 is formed in the shape of tracks on an insulating substrate 31. Further, as shown in FIG. 1, coil pattern 32 of FP coil 3 shown in FIG. 3 and the front surface of magnet 4 shown in FIG. 2 are disposed to face each other. In coil pattern 32, a direction of current flowing through an upper half portion 32a and a direction of current flowing through a lower half portion 32b are both indicated by arrows I, and the directions are opposite to each other.

Upper half portion 32a and lower half portion 32b are provided to face N-pole magnetized region 4n and S-pole magnetized region 4s of magnet 4, respectively. Accordingly, in the structure having magnet 4 shown in FIG. 2, FP coil 3 shown in FIG. 3, and yoke 5, when current flows in FP coil 3 in the direction indicated by arrows I, FP coil 3 is applied with a force exerted toward an upper side of the plane of the drawing as indicated by an arrow F, that is, a force exerted from S-pole magnetized region 4s to N-pole magnetized region 4n. Consequently, lens driving unit 1 can move lens holder 2 along shaft-like guide members 71 and 72, and position the group of lenses at a focus point.

The position of lens holder 2 is fixed by means of a lock mechanism after the group of lenses is moved to the focus point. As a component of the lock mechanism, magnetic member 6 is disposed in lens holder 2. Accordingly, even when no current flows in coil pattern 32, magnetic attraction force is generated between magnet 4 and magnetic member 6. Therefore, lens holder 2 is pressed against shaft-like guide members 71 and 72 by the magnetic attraction force. As a result, the position of lens holder 2 is fixed relative to the casing such that the position of the group of lenses is fixed at the focus point.

In the lens driving unit in the present embodiment, lens holder 2 is provided with one through-hole 21 and one cutout portion 22. However, lens holder 2 may be provided with a plurality of through-holes, for example two through-holes. Further, lens holder 2 may be provided with a plurality of cutout portions, for example two cutout portions. Furthermore, lens holder 2 may be provided with only one of a through-hole or a cutout portion.

### Second Embodiment

Referring to FIG. 4, a lens driving unit in a second embodiment of the present invention will now be described. It is to be noted that, in the present embodiment and embodiments described later, parts and members identical or corresponding to those in the lens driving unit in the first embodiment will be designated by the same reference numerals as those in the lens driving unit in the first embodiment, and the description thereof will not be repeated unless specifically needed.

FP coil 3 is disposed on each of two opposite parallel side surfaces of lens holder 2. Each of the two FP coils 3 faces magnet 4. FP coil 3 and magnet 4 are disposed to have gap. G therebetween. Yoke 5, which is a magnetic body, is attached on a back surface of each of the two magnets 4. Further, two magnetic members 6a, each in the shape of a rectangular column, are disposed in lens holder 2 in the proximity of FP coils 3. Magnetic members 6a are fixed to lens holder 2 with an adhesive (not shown) or the like.

Specifically, in the lens driving unit in the present embodiment, magnetic member 6a, FP coil 3, magnet 4, and yoke 5 are provided in two sets. Consequently, in the lens driving unit in the present embodiment, the position of lens holder 2 can be fixed with higher accuracy, compared to the lens driving unit in the first embodiment. It is to be noted that, although two magnetic members 6a are disposed in lens holder 2 in the present embodiment, only one magnetic member 6a may be disposed in lens holder 2.

### Third Embodiment

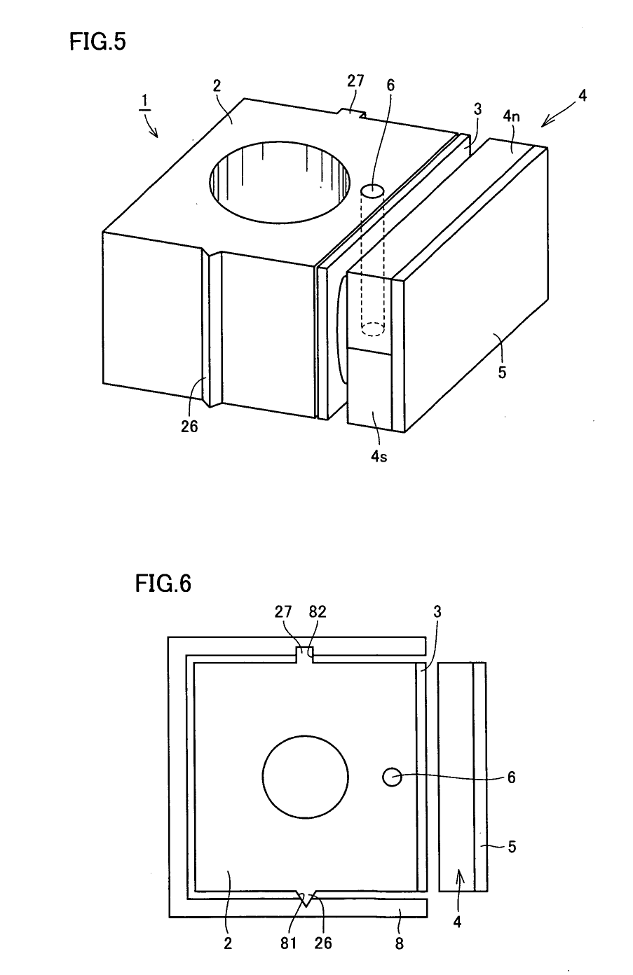

Referring to FIGS. 5 and 6, a lens driving unit in a third embodiment of the present invention will now be described. As shown in FIGS. 5 and 6, the lens driving unit in the present embodiment is different from the lens driving unit in the first embodiment in that first and second convex guide portions 26 and 27 formed on an outer side surface of lens holder 2 and first and second concave guide portions 81 and 82 formed on an inner side surface of a casing 8 are used as a mechanism for guiding lens holder 2, instead of shaft-type guide member 71, through-hole 21, and cutout portion 22.

Further, as shown in FIG. 6, lens driving unit 1 in the present embodiment is mounted in casing 8 of the camera apparatus. As seen from FIG. 6, when the camera apparatus is seen along a direction in which lens holder 2 is moved relative to casing 8, the first convex guide portion 26 has a triangular cross section, and the second convex guide portion 27 has a rectangular cross section. Further, the first concave guide portion 81 having a triangular cross section and the second concave guide portion 82 having a rectangular cross section are formed at positions in casing 8 corresponding to convex guide portions 26 and 27, respectively.

According to lens driving unit 1 in the present embodiment, the first and second convex guide portions 26 and 27 slide along the first and second concave guide portions 81 and 82, respectively, to move lens holder 2 along an optical axis.

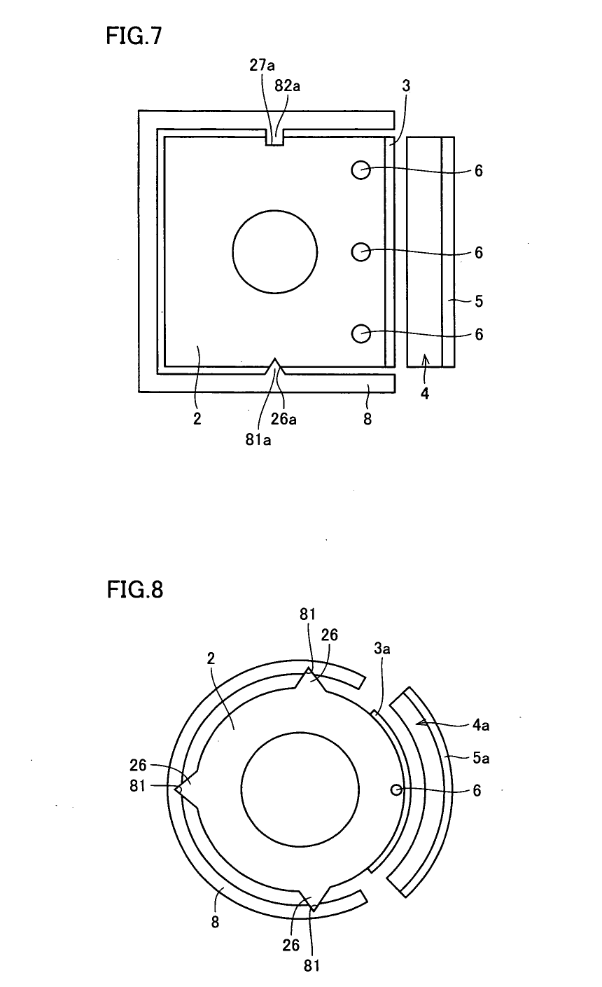

Although one magnetic member 6 is disposed in lens holder 2 in the present embodiment, a plurality of magnetic members 6 may be disposed in lens holder 2. When for example three magnetic members 6 are disposed in lens holder 2 as shown in FIG. 7, lens holder 2 is pressed against casing 8 more strongly. As a result, the position of lens holder 2 is fixed more securely. Consequently, lens driving unit 1 has an improved resistance to impact.

Further, as shown in FIG. 7, casing 8 may have first and second convex guide portions 81a and 82a, and lens holder 2 may have first and second concave guide portions 26a and 27a. In this case, the first and second concave guide portions 26a and 27a engage and slide along the first and second convex guide portions 81a and 82a, respectively.

### Fourth Embodiment

Referring to FIG. 8, lens driving unit 1 in a fourth embodiment of the present invention will now be described. Lens driving unit 1 in the present embodiment is also mounted in casing 8 of the camera apparatus, as with the lens driving unit in the third embodiment. When lens driving unit 1 is seen along the direction in which lens holder 2 is moved relative to casing 8, lens holder 2 has a substantially cylindrical shape. A peripheral surface of lens holder 2 is provided with three convex-guide portions 26 each having a triangular cross section, as guide portions.

An FP coil 3a in the shape of a curved surface is attached on the peripheral surface of lens holder 2 with an adhesive (not shown) or the like. A magnet 4a in the shape of a curved surface is disposed at a position facing FP coil 3a. A yoke 5a in the shape of a curved surface, which is a magnetic body, is attached on a back surface of magnet 4a by magnetic attraction. One magnetic member 6 is disposed in lens holder 2 in the proximity of FP coil 3a.

Concave guide portion 81 having a triangular cross section is formed in casing 8 at each of the positions corresponding to the three convex guide portions 26. In the present embodiment, convex guide portion 26 slides along concave guide portion 81. Further, magnetic attraction force is generated between magnetic member 6 and magnet 4a. Consequently, lens holder 2 is moved and fixed to casing 8 in the same way as lens holder 2 in the third embodiment.

### Fifth Embodiment

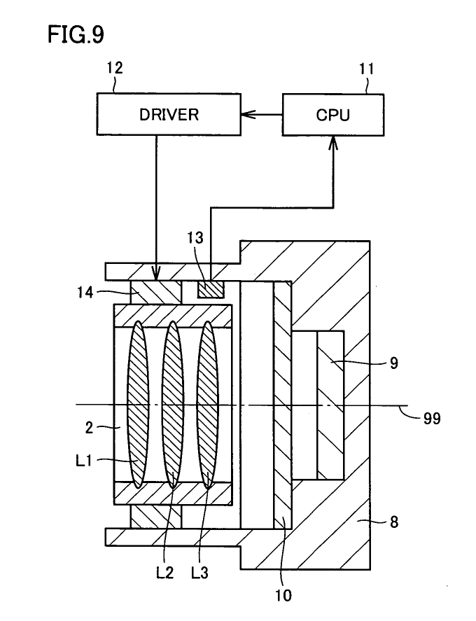

Referring to FIG. 9, a camera module having the lens driving unit of the present invention will now be described. Any of the lens driving units in the first to fourth embodiments can be mounted in the camera module.

As shown in FIG. 9, casing 8 is provided with lens holder 2, an IR (Infrared Ray) cut filter 10 for cutting off light in an infrared region (having a wavelength of not less than 700 nm) to improve color reproductivity, and an image sensor 9 such as a CCD (Charge Coupled Device) or a CMOS (Complementary Metal Oxide Semiconductor). Optical information from an object passes through lenses L1, L2, and L3 in lens holder 2 and IR cut filter 10 along an optical axis 99, and is imaged onto image sensor 9.

Casing 8 is further provided with a position sensor 13. Position sensor 13 detects the position of lens holder 2. It is to be noted that position sensor 13 need not to be provided in lens driving unit 1 if casing 8 is provided with a stopper and the group of lenses is positioned at the focus point when lens holder 2 comes into contact with the stopper.

A signal from position sensor 13 is supplied to a CPU (Central Processing Unit) 11. A control signal is supplied from CPU 11 to a driver 12. Driver 12 sends a signal to an actuator 14 including FP coil 3, magnet 4 (4a), and yoke 5 (5a), to move lens holder 2.

Also in the present embodiment, magnetic member 6 (6a) is disposed in lens holder 2.

The present invention is not limited to the lens driving unit in the embodiments described above. The structure of the lens driving unit in the embodiments described above may be modified as long as the object of the present invention can be achieved.

For example, although lens driving unit 1 in the embodiments described above has a convex guide portion formed on the lens holder and a concave guide portion formed in the casing as a mechanism for guiding the lens holder, the lens driving unit of the present invention may have a concave guide portion formed in the lens holder and a convex guide portion formed on the casing. Further, the cross sectional shape of each of the convex guide portion and the concave guide portion is not limited to a triangular shape or a rectangular shape, and the portions may have any cross sectional shape as long as the paired portions can engage and slide along each other.

Although an FP coil is used as a coil, a wire-wound coil having a small thickness may be used.

Although a circular column-shaped magnetic member and a rectangular column-shaped magnetic member have been described as a magnetic member, the magnetic member of the present invention is not limited to those, and may be a triangular column or a column having any other polygonal cross section. It is preferable from the viewpoint of holding the lens holder in a stable manner that the magnetic member has a shape extending along an optical axis. Further, the length of the magnetic member in the direction of the optical axis is preferably substantially equal to the length of the magnet in the direction of the optical axis, and more preferably longer than the length of the magnet in the direction of the optical axis.

Although the lens driving unit integrally moving a group of lenses accommodated in one lens holder has been described in each of the embodiments described above, the present invention is not limited to this. The present invention is also applicable for example to a lens driving unit moving a single lens (or a group of lenses) for focusing or a single lens (or a-group of lenses) for zooming.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A lens driving unit, comprising:
a lens holder accommodating one lens or not less than two lenses;
a coil disposed on a surface of said lens holder;
a magnet disposed at a position spaced from said coil by a predetermined distance to move said lens holder along an optical axis according to current flowing in said coil;
a guide member guiding movement of said lens holder along the optical axis; and
a magnetic member disposed at said lens holder to fix a position of said lens holder by magnetic attraction force exerted by said magnet when no current flows in said coil.

2. The lens driving unit according to claim 1, wherein said magnetic member has a shape of a column.

3. The lens driving unit according to claim 1, wherein
said lens holder includes a through-hole formed to allow insertion of a shaft-like guide member, and
said guide member includes the shaft-like guide member inserted into said through-hole.

4. The lens driving unit according to claim 1, wherein
said lens holder includes a cutout portion formed to allow insertion of a shaft-like guide member, and
said guide member includes the shaft-like guide member inserted into said cutout portion.

5. The lens driving unit according to claim 1, wherein
said lens holder includes a convex guide portion formed on a side surface thereof, and
said guide member includes a concave guide portion engaging said convex guide portion.

6. The lens driving unit according to claim 1, wherein
said lens holder includes a concave guide portion formed on a side surface thereof, and
said guide member includes a convex guide portion engaging said concave guide portion.

7. The lens driving unit according to claim 1, wherein said coil is a pattern coil.

8. The lens driving unit according to claim 1, further comprising a yoke attached to said magnet.

9. The lens driving unit according to claim 1, further comprising:
an additional coil disposed on a surface of said lens holder in addition to said coil; and
an additional magnet disposed at a position spaced from said additional coil by a predetermined distance to move said lens holder along the optical axis according to current flowing in said additional coil.
